(19) United States
(12) Patent Application Publication
(10) Pub. No.: US 2007/0123182 A1
(43) Pub. Date: May 31, 2007

(54) Local oscillator leakage cancellation in radio transmitter

(75) Inventor: Andre Dekker, Oulu (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/431,637

(22) Filed: May 11, 2006

(30) Foreign Application Priority Data
Nov. 30, 2005 (FI) 20055632

(51) Int. Cl. H04B 1/04

(52) U.S. Cl. 455/114.1

(57) ABSTRACT

The invention relates to a radio transmitter, including means for up-converting an input signal by mixing the input signal with a local oscillation signal, means for extracting an observation signal from the up-converted signal, means for switching the observation signal between an ON state allowing throughput of the observation signal and an OFF state preventing throughput of the observation signal, means for down-converting the observation signal by mixing the observation signal with the local oscillation signal, means for filtering signal components around the down-converted oscillation signal, means for generating a compensation signal by using the filtered signal in the ON and OFF states of the observation signal throughput, and means for modifying the input signal with the compensation signal.

### FIELD

The present invention relates to local oscillator leakage cancellation in a radio transmitter.

### BACKGROUND

In radio transmitters, a local oscillator (LO) is used to up-convert a modulated analog baseband or intermediate frequency signal to the final radio frequency (RF). All practical up-converters pass part, unintentionally, of the LO signal to their output. The LO may also leak in other ways to the transmitter output. The presence of an LO signal can in many ways be harmful to the transmitter, such as by generating switching transients in a TDMA transmitter or by extra loading of the power amplifier. In transmitter architectures based on an intermediate frequency, it is in principle possible to suppress the LO leakage by filtering. However, if the LO frequency is too close to the desired signal band, the filter requirements may become impractical. In direct conversion architectures, the LO is inside the transmitted signal bandwidth and needs to be cancelled in another way.

Since LO leakage depends on environmental factors, such as temperature and aging, in practice LO cancellation methods need to be adaptive. In the prior art, LO cancellation has been suggested to TDMA (Time Division Multiple Access) based transmitters. Then, LO parameters, such as leakage, may be estimated by comparing measurements on active and idle timeslots. The prior art methods are, however, not applicable to transmitters wherein transmission is continuous.

### BRIEF DESCRIPTION

In one aspect of the invention, there is provided a radio transmitter, including means for up-converting an input signal by mixing the input signal with a local oscillation signal, means for extracting an observation signal from the up-converted signal, means for switching the observation signal between an ON state allowing throughput of the observation signal and an OFF state preventing throughput of the observation signal, means for down-converting the observation signal by mixing the observation signal with the local oscillation signal, means for filtering signal components around the down-converted oscillation signal, means for generating a compensation signal by using the filtered signal in the ON and OFF states of the observation signal throughput, and means for modifying the input signal with the compensation signal.

In another aspect of the invention there is provided a chipset, including means for up-converting an input signal by mixing the input signal with a local oscillation signal, means for extracting an observation signal from the up-converted signal, means for switching the observation signal between an ON state allowing throughput of the observation signal and an OFF state preventing throughput of the observation signal, means for down-converting the observation signal by mixing the observation signal with the local oscillation signal, means for filtering signal components around the down-converted oscillation signal, means for generating a compensation signal by using the filtered signal in the ON and OFF states of the observation signal throughput, and means for modifying the input signal with the compensation signal.

In still one aspect of the invention there is provided a method in a radio transmitter, including steps of up-converting an input signal by mixing the input signal with an oscillation signal, extracting an observation signal from the up-converted signal, switching the observation signal between an ON state allowing throughput of the observation signal and an OFF state preventing throughput of the observation signal, down-converting the radio frequency signal by mixing the radio frequency signal with the oscillation signal, filtering signal components around the down-converted oscillation signal, generating a compensation signal by using the filtered down-converted signal in the ON and OFF states of the observation signal throughput, and modifying the input signal with the compensation signal.

Preferred embodiments of the invention are disclosed in the dependent claims.

The invention relates to cancellation of LO leakage in a radio transmitter, such as a base station or a mobile phone. In the invention, the radio transmission is continuous, or there is at least a continuous leakage path between the transmitter LO input and the transmitter output. In the invention, the RF signal input to an observation receiver of the transmitter is switched periodically ON and OFF and the LO cancellation is based on the difference between the demodulator output in the OFF/ON states of the RF signal input. In hardware, this difference may be achieved by periodically inverting the output of the demodulator synchronously with the operation of the RF switch. Integrated quadrature demodulators may have differential outputs, and thus their polarity may be inverted by means of switches. In another embodiment, demodulator outputs may be sampled in an analog-to-digital converter (ADC) and polarity inversion may be performed in the digital domain.

The invention provides advantages, such as making effective LO cancellation possible in a transmitter using continuous transmission. Implemented digitally, the cancellation loop of the invention has the advantage of higher accuracy and lower cost, since the cancellation loop can then be integrated with the other digital circuitry in the TX (transmitter). The ADC needs to process only low frequencies, and such ADCs are low cost commodity items.

The invention may also be applied to intermediate frequency architectures. In such a case it will relax the LO suppression requirements of the filter(s). A lower suppression requirement allows fewer, smaller and cheaper filters. Alternatively, it allows the use of a lower intermediate frequency (IF). In the case of digital generation of the IF signal, a lower IF allows a cheaper digital-to-analog converter (DAC) to be used.

### BRIEF DESCRIPTION OF THE DRAWINGS

In the following, the invention will be described in greater detail by means of preferred embodiments and with reference to the attached drawings, in which

FIG. 1 shows one embodiment of an apparatus according to the invention;

FIG. 2 shows a timing diagram of the apparatus of FIG. 1;

FIG. 3 shows another embodiment of an apparatus according to the invention;

FIG. 4 shows a timing diagram of the apparatus of FIG. 3;

FIG. 5 shows still another embodiment of an apparatus according to the invention;

FIG. 6 shows a timing diagram relating to the apparatus of FIG. 5;

FIG. 7 shows still another embodiment of an apparatus according to the invention;

FIG. 8 shows an embodiment of a method according to the invention.

### DETAILED DESCRIPTION

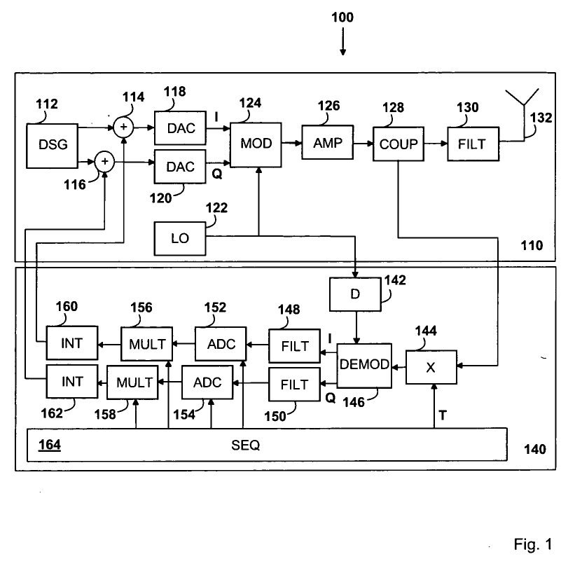

FIG. 1 shows one embodiment of an apparatus of the invention. In short, the embodiment of FIG. 1 shows a transmitter 100, which receives a digital input signal. In the transmitter, digital compensation signals are formed to correct errors caused by components of the transmitter, and the digital compensation signals are used for modifying the digital input signal.

In the embodiment of FIG. 1, the functionality of the transmitter 100 has been split between a transmitting unit 110 and an observation receiver 140. The transmitting unit includes functional entities, which together form a transmit signal to be transmitted on a radio path. The observation receiver 140 is a functional entity, which receives a portion of the transmit signal, observes possible errors in the transmit signal, and provides compensation signals to correct errors in the transmit signal.

In the transmitting unit 110, the digital signal generator 112 provides an input signal, which may be either a baseband signal or a modulated intermediate frequency (IF) signal. Typically, baseband signals are in complex format including in-phase (I) and quadrature (Q) components. An intermediate frequency signal can be either in real or in complex format. The compensation signals are generally provided in complex format.

The digital signals are converted to the analog domain in digital-to-analog converters (DACs) 118 and 120. If the digital signal is in real format, the lower DAC 120 is not used in the provision of the transmit signal, but it may still be needed in the cancellation loop when correcting errors in the transmitter. In the case of a digital baseband signal, the signal at the modulator 124 output becomes centered around a local oscillator frequency fLO. In the case of a real intermediate frequency signal at frequency fIF, the modulator 124 output contains signals at frequencies f_{LO}+f_{IF} and f_{LO}−f_{IF}, one of which needs to be removed by filtering. If the IF signal is generated in complex format, both DACs 118, 120 are used in the signal path, and the quadrature modulator 124 functions as an image reject up-converter. Depending on the phasing between the I and Q signals, the output ideally shows either the frequency F_{LO}+f_{IF} or F_{LO}−f_{IF}. In practice, the image is still present, but at a much lower power than the desired frequency, so that less filtering is needed to obtain its final rejection.

The RF signal at the modulator 124 output is further processed before it is fed to the antenna 132. This processing typically includes several amplification stages 126, power control (not shown), and filtering 130. At some point in the chain, a sample of the signal is taken to the LO cancellation loop by a sampler 128, which can be a coupler, for instance. The sampling point may in principle be anywhere between the modulator 124 output and the antenna. In some embodiments, the sampling point may be put as far downstream (close to the antenna 132) as possible to include as many LO leakage paths as possible, but before substantial amounts of power control and filtering which could interfere with the operation of the cancellation loop of the observation receiver 140.

In the embodiment of FIG. 1, the sampled signal is fed via an RF switch 144 to a quadrature demodulator 146. The local oscillator signal provided by the local oscillator 122 to the demodulator 146 is a copy of the oscillation signal fed to the modulator 124, but delayed in a delay element 142 to correspond to the delay of the RF signal path leading to the demodulator 146.

Important is the correct phasing of the oscillation signal. A leakage component detected at the I-output of the demodulator 146 may be reduced by providing a correction signal to the I-input of the modulator 124. Similarly, a leakage component detected at the Q-output of the demodulator 146 may be reduced by providing a correction signal to the Q-input of the modulator 124. However, simulations show that the phasing does not need to be very accurate. The phasing mainly effects loop dynamics, but not the final rejection. For the best performance, the phase error should be less than 30°. Even at phase errors between 45° and 90°, when the demodulated I signal correlates more to the transmitted Q than to the transmitted I signal, the loop still operates. However, the closer the phase error gets to 90°, the slower and the more oscillatory the settling becomes. It is not absolutely necessary to adjust the system to a demodulation phase error around 0°. With a phase error around 180°, the loop will operate correctly with inverted polarity. When the phase error is around 90° or 270°, the loop can be made to operate correctly by swapping the I- and Q-outputs of the observation receiver, possibly combined with polarity inversion.

As further shown by FIG. 1, at the demodulator 146 outputs the signal is directed to low-pass filters 148, 150 for filtering, in order to separate the detected LO leakage from the other signal components present in the RF signal. The low-pass filtered signals are sampled in analog-to-digital converters (ADC) 152, 154, and multiplied in multipliers 156, 158 either by a number “a” or “b”, depending on the state of the RF switch 144. The number “a” may be an exact or approximate inverse number of “b”. As an example, “a” can be (+1) and “b” can be (−1). In one embodiment, the sampling and multiplication interval is equal to the switch interval when one sample is taken at each switch interval.

Alternatively, more than one conversion sample may be taken per state of the RF switch, which is called oversampling. These samples are multiplied by a series of numbers. So if, for instance, [s1a, s2a, . . . , s8a] are the samples produced in one switching interval, and [s1b, s2b, . . . , s8b] are the samples produced in the other switching interval, the output of the multiplier 156 consists of the samples [a1·s1a, a2·s2a, . . . a8·s8a, b1·s1b, b2·s2b, . . . b8·s8b]. One example of this kind of windowing is a rectangular window with a1=a2=. . . =a8 (=1)and b1=b2=. . . =b8 (=−1).

Oversampling allows some of the low-pass filtering to be carried out in the digital domain, which might save costs in the implementation of the analog low-pass filters 148, 150, but needs higher dynamic range in the ADCs 152, 154. In the case of oversampling, it is also possible to multiply the conversion samples with a windowing function instead of a constant number as explained above. Windowing in the time domain is one possible way to achieve filtering in the frequency domain. The multiplier 156, 158 outputs are fed into loop filters 160, 162, which are typically integrators. The loop filters average out the fast fluctuations at their input and determine the dynamic behaviour (e.g. settling time) of the loop. The loop filters can be either inverting or non-inverting. The correct polarity depends on the phasing of the signals in the loop. In FIG. 1, the control unit 164 controls that sampling in the ADCs 152, 154 and the multiplication in multipliers 156, 158 occur according to the control of the RF switch 144. Finally, in the transmitter 100, the loop filter outputs are digitally summed in summing units 114, 116 to the inputs of the DACs steering the quadrature modulator 124.

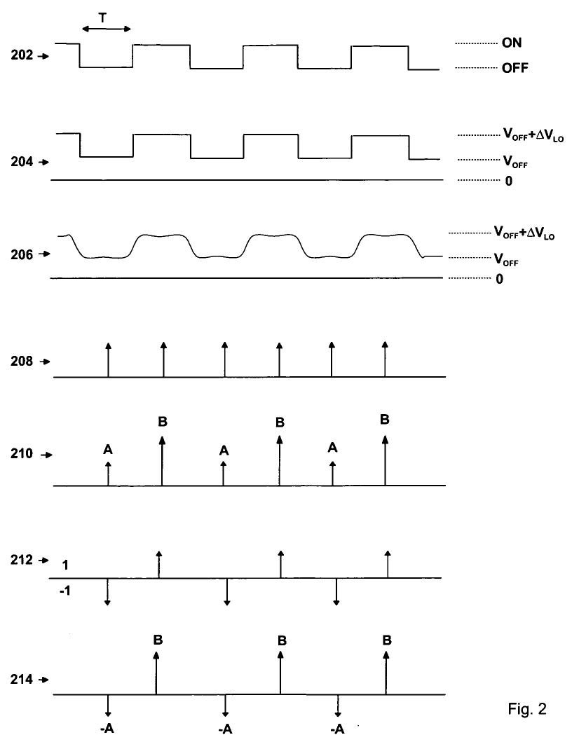

The timings of the digital cancellation loop of the observation receiver 140 are shown in FIG. 2. The first graph 202 shows the timings of the switch 144 controlling the input of the radio frequency signal. The length of each period is designated as T. In the ON state, the radio frequency signal is passed, whereas the signal throughput is blocked in the OFF state of the switch.

Graph 204 shows the output of the demodulator 146. For the sake of clarity, only the demodulated LO leakage component is shown and not the modulation on the transmitted signal. When the RF switch is in OFF state, the output of the demodulator is equal to its offset voltage V_{off}. When the RF switch is in ON state, the detected LO leakage component ΔV_{LO} is added to the offset voltage and the output of the demodulator is V_{off}+ΔV_{Lo}.

The output of the low-pass filters 148, 150 is shown in graph 206.

Sampling clock samples 208 provided by the sequencer 164 synchronously to the switch interval T are used in the analog-to-digital converters 152, 154 to determine the moments of conversion to the digital domain. The output 210 of the analog-to-digital converter 152, 154 is indicated by A corresponding to the offset voltage when the RF signal input is disabled (OFF state). The output 210 is indicated by B corresponding to the sum of the offset voltage and the leakage voltage when the RF signal input is enabled. The LO leakage voltage is thus the difference B−A.

The input to the integrator is inverted by using multiplication factors 212 provided by the multipliers 156, 158 to give output 214. The output of the ADCs may be inverted (multiplication by −1) when the RF switch is OFF and the output is not inverted (multiplication by −1) when the RF switch is ON. Hence, the integrator input signal is given by

$${V}_{int} = \{ \begin{matrix}{V}_{off} + Δ {V}_{LO} , & ON \\ - {V}_{off} , & OFF\end{matrix}$$

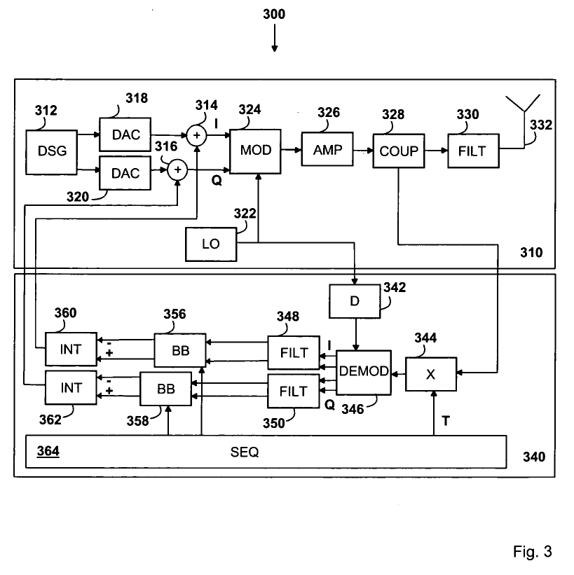

according to the states ON/OFF of the RF switch 144. Assuming a 50% duty cycle, the offset voltage cancels in the averaging process in the loop filter, that is, in successive moments of time, voltages −A and A (A is included in B) are present in the loop filter input. Half of the detected LO leakage, which is present in B, remains, because the leakage is only passed in one of the two states of the RF switch. FIG. 3 shows one embodiment of a transmitter 300 with leakage detection and compensation in the analog domain. The operation of the transmitter unit 310 is similar to the implementation of the transmitter unit 110 in FIG. 1 except that the adding units 314, 316 come in the transmit chain after the digital-to-analog converters 318, 320. That is, in the embodiment of FIG. 3, the compensation signals are added to an analog signal in contrast to the digital addition of compensation signals shown in FIG. 1.

In the observation receiver 340, the difference as opposed to the observation receiver 110 in FIG. 1, starts at the output of the low-pass filters 348, 350 after the quadrature demodulator 346. While in the digital implementation of FIG. 1 the signals were first converted to the digital domain before polarity switching, in the analog implementation of FIG. 3 the polarity of the analog signal may be switched directly after low-pass filtering. For differential signals the polarity can be switched without introducing new DC offset errors, just by swapping the inverted and non-inverted signal component. When the RF signal input is in OFF state, the baseband signal may be inverted, and correspondingly when the RF signal input is in ON state, the baseband signal is not inverted.

The output signals of the switches 356, 358 are fed to analog loop filters 360, 362, typically integrators. Control unit 364 controls that the polarity switching of the switches 356, 358 is performed in alignment with the RF input enablement/disablement in the RF switch 344.

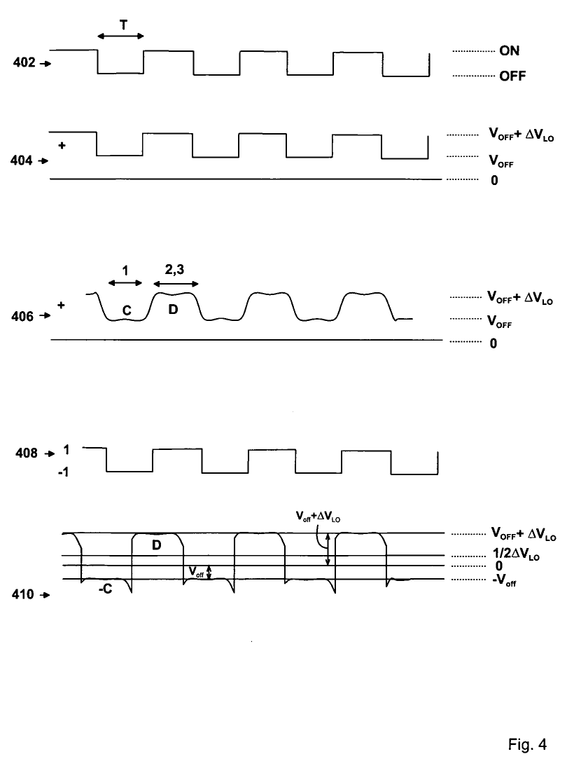

FIG. 4 shows the timings in the analog embodiment of FIG. 3. The first graph 402 again shows the timings of the RF signal input, wherein T is the length of the ON/OFF state.

Graph 404 shows the differential output of demodulator 346, i.e. the difference between its positive and negative output. Correspondingly to the timing in FIG. 2, in the OFF state of the RF switch, the offset voltage of the demodulator is obtained and in the ON state of the switch, the output is the sum of the offset voltage and the leakage voltage. Graph 406 shows the differential low-pass filter output. The base band switches 356, 358 may be controlled by the control shown by graph 408, that is, at one RF switch interval T, the BB switch inverts the differential signal, and at another switch interval T, the BB switch does not invert the signal. This is highlighted by FIG. 4 such that when the inversion takes place, signal portion C is inverted. At the moment when no inversion takes place, signal portion D is not inverted in graph 410.

The control of the baseband switches should be somewhat delayed to the control of the RF switch, in order to accommodate the delay in the low-pass filters.

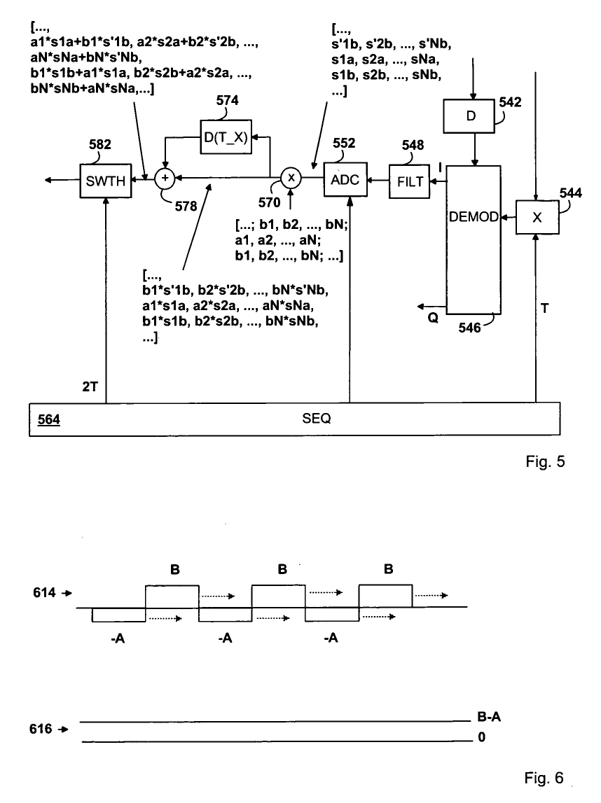

FIG. 5 shows still another embodiment of an observation receiver according to the invention. Only the I-branch is depicted in the Figure but the Q-branch may be implemented correspondingly. As shown in FIG. 2, the input of the loop filter alternates between the voltages A and B. Thus, the input signal contains an alternating current component at the switching frequency which appears at the output of the loop filter when its bandwidth is not sufficiently small. Alternatively, one may feed only the differences between pairs of samples B and A of low-pass filter outputs, which is achieved by the transmitter of FIG. 5.

In one of the states of the RF switch 544, the ADC 552 outputs a set of samples [s1a, s2a, . . . , sna] the sample interval thus being a multiple of the switch interval. In the other state of the RF switch, the ADC 552 outputs a set of samples [s1b, s2b, . . . , snb]. Let the corresponding samples in the previous ON-OFF cycle of the RF switch be denoted by a prime, thus for instance s'1b is s1b in the previous ON-OFF cycle. The samples are multiplied in a multiplication node 570. The multiplication is carried out using sample-specific multiplication factors. Factors/series a=[a1, a2, . . . aN] are used for multiplying the samples A=[s1a, s2a, . . . , sna] and factors/series b=[b1, b2, . . . , bn] for multiplying the samples B=[s1b, s2b, . . . , snb]. The multiplier outputs are thus [s1a*a1, s2a*ba, . . . , sna*ba, s1b*b1, s2b*b 2, . . . , snb*bn]. The multiplication series a and b may be substantially opposite to each other. Without oversampling, only one sample or multiplication factor exists per switch state, meaning n=1. With oversampling, n is more than 1. After the multiplier 570 the signal is branched. The upper branch is delayed by one switch interval of the RF switch. The samples at the output of the delay belong to one earlier state of the RF switch, so they are given by [s'1b*b1, s'2b*b2, . . . , s'nb*bn, s1a*a1, s2a*ba, . . . , sna*ba]. The direct and delayed samples are summed, the result being the series [s1a*a1+s'1b*b 1, . . . , sna*an+s'nb*bn, s1a*a1+s1b*b1, . . . , sna*an+snb*bn]. The effect of the delay in one branch is thus to time align the samples belonging to the ON state and OFF state of the RF switch, so that they can be combined simultaneously instead of alternately. This removes the switching frequency from the input of the loop filter.

As shown by FIG. 5, the generating means generates the compensation signal for a particular moment by using the filtered down-converted observation signals both in the ON and OFF states of the switching means.

FIG. 6 highlights alignment of sample windows. Sample sets A and B in graph 614, each relating to one of the switch states, are aligned in time over each other. In this example sample set A is multiplied by −1 and sample set B by 1, so that the output signal is B−A shown by 616.

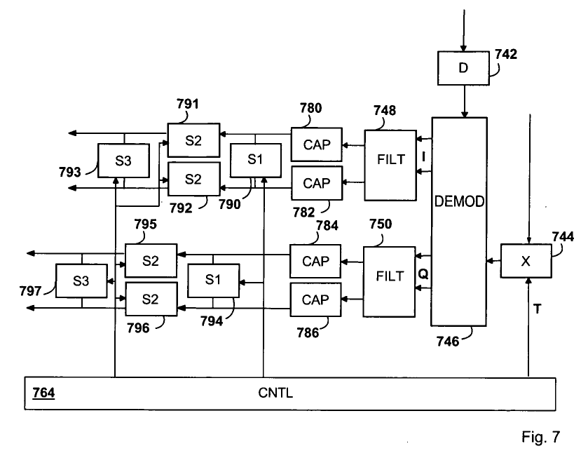

FIG. 7 shows still another embodiment in the analog domain. During the time the RF switch 744 is open and the outputs of the low-pass filters 748, 750 have settled, the baseband switches marked by S1 790, 794 are closed and the DC offset of the demodulator 746 is stored into the capacitors 780, 782, 784, 786. This time is marked as “⇄1” in the output voltage 406 of the LPF in FIG. 4. During the time the RF switch 744 is closed and the out-puts of the low-pass filters 748, 750 have settled again, the baseband switches marked by S2 791, 792, 795, 796 are closed while those marked by S3 793, 797 are open. In FIG. 4, this time is marked as “⇄2, 3”. During this time, the demodulated LO leakage is passed to the loop filter, with the DC offset voltage stored in the capacitors subtracted from it. Outside the time interval “2, 3”, switches S3 are closed and switches S2 are open, so that the loop filter has no input signal and—assuming an integrating loop filter—its output will not change. The function of switch S1 is thus to clamp the constant part of signal portion C of graph 406 in FIG. 4 to zero and in that way to shift the whole graph in vertical direction. With the shown arrangement of switches, the circuit behaves similarly to that in the embodiment of FIG. 5, only passing the difference between the settled states of the LPFs 748, 750 to the loop filters. In one embodiment, the switches S2 and S3 are omitted and the signals to the loop filters are taken from the terminals of switches S1. In that way the whole signal portion D in graph 406 is passed to the loop filter, including the rising and falling slopes. As such these slopes are not harmful to loop operation, because they also contain some of the detected LO leakage. However, switches S2 and S3 are advantageous if the loop filter inputs draw DC bias currents. S3 can short-circuit the loop filter inputs at moments when no full input signal is available, thus minimizing the offset errors due to the bias currents.

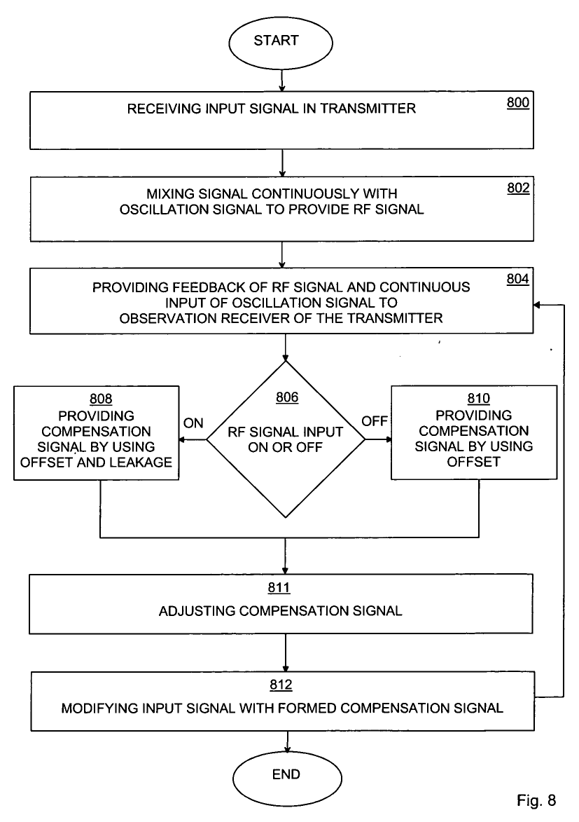

FIG. 8 shows one embodiment of a method according to the invention. A signal, either a baseband or an intermediate frequency signal, is generated and received 800 in a transmitter. This signal is up-converted 802 to a radio frequency signal. In one embodiment, an in-phase component and a quadrature component being 90 degrees phase-shifted to the in-phase component are provided. In another embodiment, only an in-phase component is provided.

The created RF signal is transmitted to the radio path in a usual manner, including certain filtering and amplifying steps. A portion from the created RF transmit signal is extracted and fed back 804 to an observation receiver of the transmitter. A copy of the oscillation signal used in up-conversion of the transmit signal is also fed to the observation receiver. The observation receiver includes an RF switch, which may toggle between having the RF signal input enabled and disabled. If the check 806 indicates that the RF signal input is enabled, the method proceeds to step 808, whereas if the RF signal input is disabled, the method proceeds to step 810.

Thus, a demodulator in the observation receiver receives the oscillation signal and the chopped RF signal. The output of the demodulator is filtered in a low-pass filter so as to reveal signal components close to the oscillation signal. In step 810, a correction to the compensation signal only containing offset voltage as compared to ideal output, is formed from the filtered output of the demodulator. In step 808, the output of the low-pass filters contains both the offset voltage and the leakage voltage, which is due to the leakage of the oscillation signal, the correction to the compensation signal being accordingly formed from both these signal components.

In step 811, the formed corrections are used for adjusting the compensation signal used in modifying the input signal to the transmitter. Both corrections may be used sequentially, or they may be combined to provide a single adjustment. The adjustment may take place in the digital or in the analog domain. For adjustment in the digital domain, the analog signal needs to be converted to a digital signal, after which every other sample may be inverted before being used for modifying the compensation signal. For adjustment in the analog domain, the polarity of the low-pass filter output may be inverted before being used for modifying the compensation signal.

In step 812, the formed compensation signal is used for modifying the input signal of the transmitter. The modification may take place in the digital or in the analog domain. If the formation of the compensation signal and the modification of the input signal do not take place in the same domain, conversion between those domains is required.

After the input signal has been modified, the RF signal is observed again to obtain a new adjustment to the compensation signal.

The figures above show only few embodiments of the invention. In another embodiment of the invention, a separate IQ modulator or vector modulator may be provided for the LO cancellation. In such a case the correction signals are passed to the separate modulator different from the modulator in the transmit path. The signals of the both modulators are then added to each other. This may be an alternative when the main up-converter is not DC coupled or does not have a quadrature input, like in intermediate frequency architectures without image rejection.

In still another embodiment of the invention, a digital loop may be arranged for providing digital compensation signals, but its outputs are converted to the analog domain via separate DACs such that the analog correction signals may be analogly added to the input signals. This embodiment may be applicable when the DACs in the transmit signal path are not DC-coupled to the quadrature modulator. Furthermore, the polarity inversion in the analog loop may also be realized in other ways than via switches. Further, the place of the periodic polarity inversion is not restricted to the places indicated in the figures, but can be at any place between the demodulator and the loop filter. In still another embodiment, after the DC offset removal, the processed outputs of the quadrature modulator may be converted to a single signal representing the power or amplitude of the LO leakage. Then, a search algorithm can be used for finding the proper combination of the I and Q components of the compensation signal such that the leakage vanishes. This embodiment provides the advantage that it allows arbitrary phase shifts between the LO inputs of the modulator and the demodulator.

The figures only show the necessary components for understanding the invention. For example, the following practical implementation aspects will be evident to those skilled in the art. Reconstruction filters may be needed at the DAC outputs, which filters may be either low-pass or band-pass ones depending on the signal and clock frequencies. Typically, the low-pass filtered outputs of the demodulator need some extra amplification before further processing. In the digital implementation, the extra amplification reduces the effect of quantization errors in the ADCs, and in the analog implementation it reduces the effect of DC offsets in the loop filters. Some of the DC offset in the demodulator is caused by LO leakage in the demodulator that is reflected back from its RF input. Therefore it is assumed that the impedance seen by the RF input of the demodulator does not depend on the state of the RF switch. This can be realized by using a non-reflective switch and/or buffer amplifiers and/or attenuators.

The invention may be implemented in hardware by using the disclosed or corresponding components.

It will be obvious to a person skilled in the art that as the technology advances, the inventive concept can be implemented in various ways. The invention and its embodiments are not limited to the examples described above but may vary within the scope of the claims.

1. A radio transmitter, including:
means for up-converting an input signal by mixing the input signal with a local oscillation signal;
means for extracting an observation signal from the up-converted signal;
means for switching the observation signal between an ON state thereby allowing throughput of the observation signal, and an OFF state thereby preventing throughput of the observation signal;
means for down-converting the observation signal by mixing the observation signal with the local oscillation signal;
means for filtering signal components around the down-converted observation signal;
means for generating a compensation signal by using the filtered signal in the ON and OFF states of the observation signal throughput; and
means for modifying the input signal with the compensation signal.

2. A radio transmitter according to claim 1, wherein:
the generating means is configured to generate the compensation signal for a particular moment by using the filtered, down-converted observation signals both in an ON state and an OFF state of the switching means.

3. A radio transmitter according to claim 1, wherein:
the down-converting means includes a demodulator; and
the generating means is configured to generate the compensation signal by using the filtered observation signal representing an offset voltage of the demodulator, when the switching means is in the OFF state.

4. A radio transmitter according to claim 1, wherein:
the down-converting means includes a demodulator;
the generating means is configured to generate the compensation signal by using the filtered observation signal representing the sum of an offset voltage of the demodulator and a leakage voltage caused by the local oscillation signal, when the switching means is in the ON state.

5. A radio transmitter according to claim 1, wherein the generating means includes means for generating a digital compensation signal; and
the modifying means is configured to digitally modify the input signal by the generated digital compensation signal.

6. A radio transmitter according to claim 1, wherein the digital compensation signal generating means includes:
means for providing a sample interval equal to a switching interval of the switching means;
means for converting the observation signal to digital samples at sample intervals;
means for multiplying the digital samples by a first number when the observation signal is in the ON state, and by a second number substantially opposite to the first number when the observation signal is in the OFF state such that the offset voltages in the ON and OFF states of the observation signal throughput cancel each other.

7. A radio transmitter according to claim 1, wherein the generating means includes:
means for providing multiple sample intervals per switching interval of the switching means;
means for converting the observation signal to digital samples at the sample intervals;
means for multiplying the digital samples by a first series of numbers when the observation signal is in the ON state, and by a second series of numbers substantially opposite to the first series of numbers when the observation signal is in the OFF state.

8. A radio transmitter according to claim 1, wherein the generating means includes:
means for providing a sample interval equal to a switching interval of the switching means;
means for converting the observation signal to digital samples at sample intervals;
means for multiplying the digital samples corresponding to a first state of the switching means by a first number, and the digital samples corresponding to the second state by a second number, the first number being substantially opposite to the second number;
means for branching the digital samples into a first signal branch and into a second signal branch;
means for delaying the digital samples in the first branch by one sample interval;
means for summing the digital samples of the first branch and the second branch to a sum signal sample.

9. A radio transmitter according to claim 1, wherein the generating means includes:
means for providing multiple sample intervals per switching interval of the switching means;
means for converting the observation signal to digital samples at sample intervals;
means for multiplying the digital samples, corresponding to a first switch state by a first set of numbers, and the digital samples corresponding to a second switch state by a second set of numbers, the first set of numbers being substantially opposite to the second set of numbers;
means for branching the digital samples into a first signal branch and into a second signal branch;
means for delaying the digital samples in the first branch by one switch interval;
means for summing the samples of the first branch and the second branch to form a set of sum signal samples.

10. A radio transmitter according to claim 1, wherein the generating means is configured to generate an analog compensation signal; and
the modifying means is configured to modify the input signal by the analog compensation signal.

11. A radio transmitter according to claim 1, wherein:
the generating means is configured to switch the filtering means output such that the filtered observation signal is forwarded either inverted or non-inverted, depending on the state of the observation signal.

12. A radio transmitter according to claim 1, including:
a demodulator; and
means for storing an output signal of the demodulator in one of the states of the observation signal, which storing means is configured to release the stored output signal in the other state of the observation signal.

13. A radio transmitter according to claim 1, wherein the generating means includes:
means for storing an analog signal;
a first switch;
a pair of second switches following the first switch; and
a third switch following the pair of second switches,
wherein when the first switch is closed and the second switches are open in one of the states of the radio frequency signal input, the output signal of the demodulator is stored in the storing means, and when the first switch and third switch are open and the second switches are closed, the out-put signal of the demodulator is passed on with the stored signal subtracted, and when the third switch is closed no signal is output.

14. A radio transmitter according to claim 1, wherein:
the up-converting means includes a first mixer and a second mixer, each of the first mixer and the second mixer inputting the oscillation signal, wherein the oscillation signals to the first mixer and second mixer are essentially 90 degrees phase-shifted with respect to each other.

15. A radio transmitter according to claim 14, wherein:
the generating means is configured to generate mixer-specific compensation signals.

16. A radio transmitter according to claim 1, wherein the input signal is a complex signal having an in-phase component and a quadrature component;
the generating means is configured to generate component-specific compensation signals; and
the modifying means is configured to modify both signal components individually with the component-specific compensation signals.

17. A radio transmitter according to claim 1, wherein the input signal is a complex signal having an amplitude component and a phase component.

18. A chipset, including:
means for up-converting an input signal by mixing the input signal with a local oscillation signal;
means for extracting an observation signal from the up-converted signal;
means for switching the observation signal between an ON state thereby allowing throughput of the observation signal and an OFF state thereby preventing throughput of the observation signal;
means for down-converting the observation signal by mixing the observation signal with the local oscillation signal;
means for filtering signal components around the down-converted observation signal;
means for generating a compensation signal by using the filtered signal in the ON and OFF states of the observation signal throughput; and
means for modifying the input signal with the compensation signal.

19. A chipset of claim 18, wherein:
the down-converting means includes a demodulator, wherein the chipset further includes:
generating means, wherein the generating means is configured to generate the compensation signal by using the filtered down-converted observation signal representing an offset voltage of the demodulator, when the observation signal is in the OFF state.

20. A chipset of claim 18, wherein:
the down-converting means includes a demodulator, wherein the chipset further includes:
a generating means, wherein the generating means is configured to form the compensation signal by using the filtered down-converted observation signal representing a sum of an offset voltage of the demodulator and a leakage voltage caused by the oscillation signal, when the observation signal is in the ON state.

21. A method in a radio transmitter, including:
up-converting an input signal by mixing the input signal with an oscillation signal;
extracting an observation signal from the up-converted signal;
switching the observation signal between an ON state thereby allowing throughput of the observation signal and an OFF state thereby preventing throughput of the observation signal;
down-converting the radio frequency signal by mixing the radio frequency signal with the oscillation signal;
filtering signal components around the down-converted radio frequency signal signal;
generating a compensation signal by using the filtered down-converted signal in the ON and OFF states of the observation signal through-put; and
modifying the input signal with the compensation signal.

22. A method according to claim 21, wherein:
generating the compensation signal by using the filtered, down-converted observation signal representing an offset voltage of a demodulator of the transmitter, when the observation signal is in the OFF state.

23. A method according to claim 21, wherein:
generating the compensation signal by using the filtered, down-converted observation signal representing a sum of an offset voltage of a demodulator of the transmitter and a leakage voltage of the oscillation signal, when the observation signal is in the ON state.

24. A radio transmitter, including:
an up-converting module that up-converts an input signal by mixing the input signal with a local oscillation signal;
an extraction module that extracts an observation signal from the up-converted signal;
a switching module that switches the observation signal between an ON state thereby allowing throughput of the observation signal, and an OFF state thereby preventing throughput of the observation signal;
a down-converting module that down-converts the observation signal by mixing the observation signal with the local oscillation signal;
a filter module that filters signal components around the down-converted oscillation observation signal;
a generator module that generates a compensation signal by using the filtered signal in the ON and OFF states of the observation signal through-put; and
a modifier module that modifies the input signal with the compensation signal.

25. A radio transmitter, including:
an first converter, wherein the first converter up-converts an input signal by mixing the input signal with a local oscillation signal;
an extractor, wherein the extractor extracts an observation signal from the up-converted signal;
a switch, wherein the switch switches the observation signal between an ON state thereby allowing throughput of the observation signal, and an OFF state thereby preventing throughput of the observation signal;
a second converter, wherein the second converter down-converts the observation signal by mixing the observation signal with the local oscillation signal;
a filter, wherein the filter filters signal components around the down-converted oscillation observation signal;
a generator, wherein the generator generates a compensation signal by using the filtered signal in the ON and OFF states of the observation signal throughput; and
a modifier, wherein the modifier modifies the input signal with the compensation signal.
